(19) United States
(12) Patent Application Publication
(10) Pub. No.: US 2011/0119877 A1
(43) Pub. Date: May 26, 2011

(54) TENSIONING DEVICE HAVING AN ILLUMINATION SOURCE AND RELATED METHOD

(76) Inventor: Stephen D. Jackson, Stockton, CA (US)

(21) Appl. No.: 12/624,367

(22) Filed: Nov. 23, 2009

(51) Int. Cl. A44B 11/02; F21S 4/00

(52) U.S. Cl. 24/68 CD; 362/249.02

(57) ABSTRACT

In one embodiment, a tensioning device having a permanently affixed illumination source disposed on the tensioning device to provide illumination during, among other things, operation of the tensioning device, is described herein.

### TECHNICAL FIELD

The disclosure herein relates to tensioning devices and related methods, and more particularly to a tensioning device having an illumination source permanently affixed to the tensioning device to provide illumination during, among other things, operation of the tensioning device.

### BACKGROUND

Tensioning devices for cargo control are an important tool for warehousemen, contractors, sportsmen, government agencies, and home owners, to name a few, and are used to control and/or secure a variety of materials on many types of vehicles (trucks, cars, aircraft, water vessels), as well as containers such as pallets, crates, and similar types of open devices having materials that may shift or separate from the container during transport or movement of the container.

Tensioning or cargo control devices are numerous and diverse in their material construction and mechanical operation. Cargo control devices include, but not limited to chain, synthetic webbing, rope, cordage, bungee, and an equally diverse family of tensioning devices including cam buckles, over-center buckles, ratchet buckles, winches, wedge blocks, and many other similar type tensioning devices.

Actual use of cargo control devices occur in many different environments, locations, and ambient conditions. Proper attachment and use of the cargo control device is essential to operator safety and containment of the cargo to prevent damage to the cargo and/or the property, and/or injury to people. Proper use involves many factors including cargo control device anchor point selection, hook type, slack or tension, and physical placement on the cargo itself.

Current industry standard tensioning devices employ many features to enhance the mechanics of the actual tie down or secure function offered by the tensioning device, but offer no visual assistance to the user or operator in the form of a visible light to illuminate the work area and assist in the proper placement and use of the cargo control device.

For example, many times a vehicle may be loaded with cargo and the cargo will be secured via a cargo control device during daylight hours, but while the cargo is moved from its point of loading to its final destination the cargo may shift and/or the cargo control device may loosen necessitating adjustment of the cargo control device. Adjustment of the cargo control device may take place under adverse conditions including inclement weather, along a roadside, and during twilight or night time hours when visibility is relatively poor. Typically, in such a scenario, a person will hold a flashlight in one hand, or more often than not hold a light source in their mouth, in a cumbersome and often mistake prone attempt to provide visibility while securing the cargo.

The tensioning device described herein addresses the safety and material control problems by providing a source of illumination directly on the tensioning device. In one embodiment, use of a permanently affixed or “on-board” illumination source disposed on the tensioning device assists the user or operator of the tensioning device in many ways. In this regard, illumination of the illumination source may be provided by one or more light emitting diodes (LED). Prior to installation and use of the tensioning device, the illumination source(s) of the tensioning device may be used to identify a secure anchor point, and to assist the user in macro and micro adjustments of the device while tensioning or releasing the tensioning device. The illumination source(s) may further assist the user in locating proper footing and handholds to avoid slips and falls, and when left in the “on” position after securing the cargo the illumination source(s) may provide illumination to warn other motorists about a potentially dangerous condition.

Further refinement of the illumination source could provide illumination outside the normal visible light spectrum such as infrared illumination for use in operations typically associated with use in military, police, or hunting activities.

Although the tensioning device is described herein as relating to a ratchet type tensioning device, it is understood that other suitable cargo control or tensioning devices and their associated components would benefit from an on-board type illumination source features. In this regard, the scope of the subject matter described herein includes not only a main portion of the tensioning devices with lights, but also envisions, where appropriate, terminal ends of the tensioning device with lights to assist the user in hook-up, release, and generally visibility.

Accordingly, there exists a need for a tensioning device and related method, and more particularly to a tensioning device having an illumination source including a light emitting diode permanently affixed to the tensioning device to provide illumination during, among other things, operation of the tensioning device.

### SUMMARY

For the purpose of summarizing the invention certain objects and advantages have been described. It is to be understood that not all such objects or advantages may be achieved in accordance with any particular embodiment. Thus, for example, those skilled in the art will recognize that the device described herein may be embodied or carried out in a manner that achieves or optimizes one advantage or group of advantages as taught herein without necessarily achieving other objects or advantages.

In one embodiment the disclosed subject matter includes a tensioning device for securing or containment of cargo, the tensioning device includes an illumination source permanently affixed to the tensioning device and positioned to provide illumination during use of the tensioning device

In another embodiment the disclosed subject matter includes a hand-held manually operated ratchet tensioning device for securing or containment of cargo, the tensioning device includes a main ratchet portion; a terminal end; a strap connected between the main ratchet portion and the terminal end; and an illumination source permanently affixed to the tensioning device, the illumination source includes a light emitting diode disposed positioned to provide illumination during use of the tensioning device.

In still another embodiment the disclosed subject matter includes a method of providing illumination during use of a ratchet tensioning device to secure cargo, the tensioning device having a main ratchet portion linked to a terminal end, the method includes the steps of permanently affixing an illumination source to the tensioning device; and positioning the illumination source to provide illumination during use of the tensioning device.

These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1A is a perspective view of a tensioning device including a terminal end each having an illumination source including a light emitting diode permanently affixed to the tensioning device to provide illumination during, among other things, operation of the tensioning device, in accordance with one embodiment.

FIGS. 1B and 1C are exemplary schematics representing a few circuit configurations of many possible circuit configurations for implementing one or more illumination sources on the tensioning device of FIG. 1A.

FIG. 2 is a perspective view of the tensioning device with the illumination source powered “on” in accordance with one embodiment.

### DETAILED DESCRIPTION

Exemplary embodiments will now be described with references to the accompanying figures, with like reference numerals referring to like elements throughout. The terminology used in the description is not intended to be interpreted in any limited or restrictive manner, simply because it is being utilized in conjunction with a detailed description of certain embodiments. Furthermore, various embodiments (whether or not specifically described herein) may include novel features, no single one of which is solely responsible for its desirable attributes or which is essential to practicing the subject matter described herein.

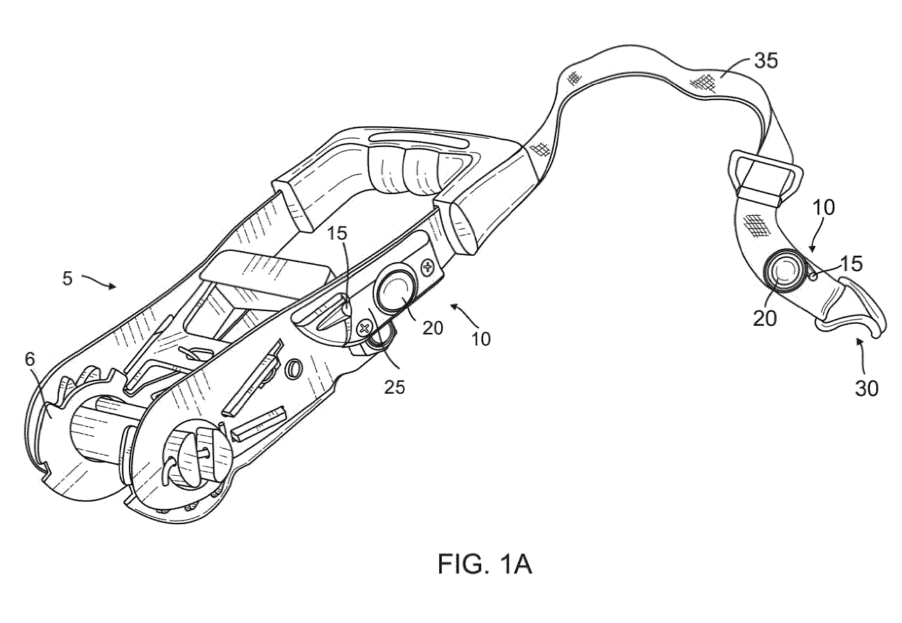

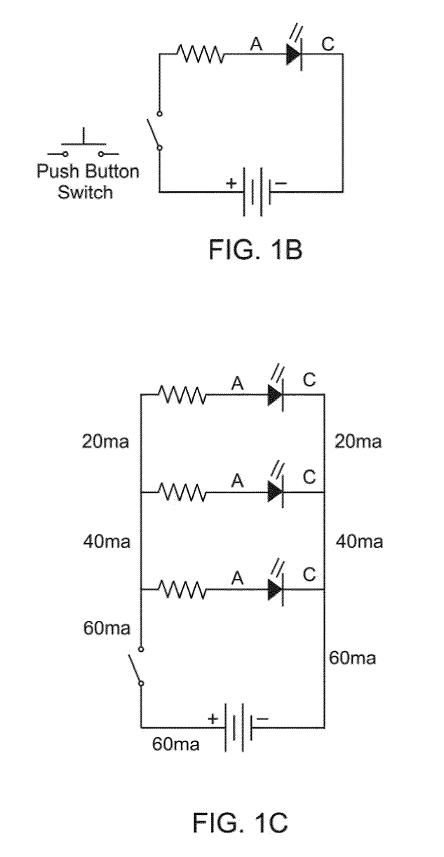

FIG. 1A is a perspective view of a tensioning device including a terminal end each having one or more illumination sources such as a light emitting diode permanently affixed to the tensioning device to provide illumination during, among other things, operation of the tensioning device, in accordance with one embodiment.

As indicated above, tensioning devices for cargo control are an important tool for control and/or securing a variety of materials on many types of vehicles (trucks, cars, aircraft, water vessels), as well as containers such as pallets, crates, and similar type of open devices having materials that may shift or separate from the container during movement of the container.

As further indicated above, tensioning devices or cargo control devices are numerous and diverse in their material construction and mechanical operation. Cargo control devices include, but not limited to chain, synthetic webbing, rope, cordage, bungee, and an equally diverse family of tensioning devices include cam buckles, over-center buckles, ratchet buckles (such as the one shown in FIG. 1A), winches, wedge blocks, and many other similar type tensioning devices.

Although the tensioning device is described herein as relating to a hand-held manually operated ratchet-type tensioning device, it is understood that other suitable cargo control or tensioning devices, as indicated above, and their associated components would benefit from one or more on-board type illumination source features, as described herein. In this regard, the scope of the disclosure envisions not only includes the main portion of the tensioning device with lights (ratchet portion of FIG. 1A), but also includes, where appropriate, terminal ends of the tensioning device with lights to assist the user in hook-up, release, and general visibility.

In this regard, the tensioning device 5 shown in FIG. 1A includes many features well-known in the art such as a manual ratchet mechanism 6 (main portion or main ratchet portion) connected at one end of a first strap 35 made of nylon or other suitable material, and a terminal end 30 such as a plastic covered hook at the other end of the first strap 35 for attachment to an attachment point such as a vehicle or container. A second strap (not shown) is typically threaded through the ratchet mechanism 6 such that when the ratchet mechanism 6 is manually operated or ratcheted, the second strap is wound around a portion of the ratchet mechanism 6 to tighten the tensioning device 5 on the cargo to secure and control the cargo for transport or similar type movement.

Current industry standard tensioning devices offer no visual assistance to the user or operator in the form of a visible light to illuminate the work area and assist in the proper positioning and use of the cargo control device. In one embodiment, the tensioning device 5 described herein addresses this problem by providing a permanently affixed illumination source 10 permanently affixed to the tensioning device 5. In one embodiment, use of an illumination source 10 including an on-board light emitting diode (LED) 15 permanently affixed to the tensioning device 5 assists the user or operator of the tensioning device 5 during, among other things, operation of the tensioning device 5.

As shown in FIG. 1A, the illumination source 10 may include a hard outer housing or enclosure 25 made of plastic or of a similar durable, impact resistant material integrally formed with the tensioning device 5. The housing 25 may include rubber seals or gaskets to reduce or eliminate potential damage caused by moisture intrusion of the illumination source 10.

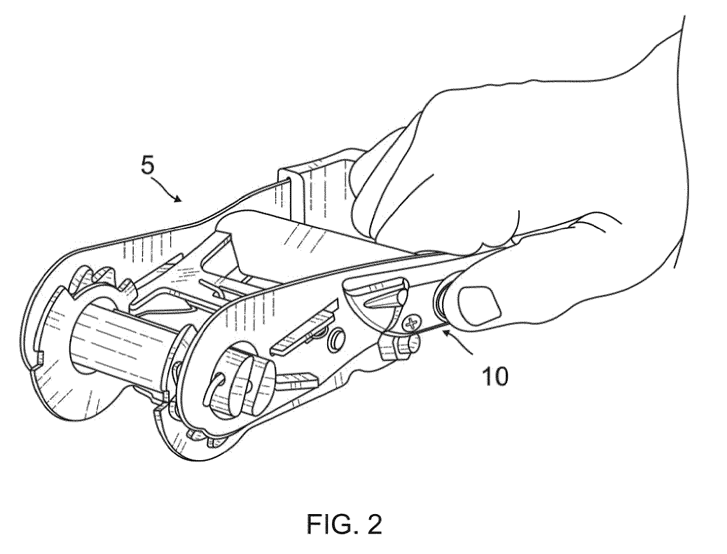

The illumination source 10 further includes one or more LEDs 15 with corresponding circuitry and power source for providing illumination, a push button assembly 20 for activation and deactivation of the one or more LEDs 15 (see FIG. 2), and associated hardware such as screws or similar connecting means for attaching the illumination source 10 to the ratchet mechanism 6 of the tensioning device 5 may be disposed within the housing 25.

Persons of ordinary skill in the art will understand that various features of the illumination source described herein, such as the push button activation is intended to encompass such related devices as a toggle switch, a slider switch, or similar type switches capable of relatively simple “on” and “off” functionality or relatively more complex functionality such as providing strobe or infrared (IR) operation.

Persons of ordinary skill in the art will further understand that the one or more LEDs described herein may further include or alternatively include colored, strode, IR, ultraviolet, florescent, incandescent, and similar types of visible or covert illumination functionality.

Furthermore, in one embodiment, although the illumination source is attached to the tensioning device 5 by screws of similar type hardware and is therefore capable of being removed, for example to change an illumination bulb, it is intended that the phrase “permanently affixed” means that the illumination source is affixed to the illumination source at all times except for those relatively few instance reserved for maintenance and the like.

As shown in FIG. 1A, the tensioning device 5 may include one or more illumination sources 10 positioned on the ratchet mechanism 6, the terminal end 30 of the first strap 35, or the terminal end of the second strap. In this regard, a single LED may be disposed within a single housing 25 while being activated/deactivated by a single pushbutton assembly 20, multiple LEDs 15 may be disposed within a single housing 25 and activated/deactivated by a single push button assembly 20, or a single pushbutton assembly 20 may activate/deactivate multiple LEDs 15 attached to different positions on the tensioning device 5.

Exemplary circuitry for operation of the one or more illumination sources 10 and the LEDs 15 are shown in FIGS. 1B and 1C. Person of ordinary skill in the art will understand that other suitable circuit configurations that permit single LED or multiple LED operation for a particular housing 25 or for multiple illumination source 10 configurations positioned on the tensioning means 5 are intended to be encompassed within the scope of the disclosure. In this regard, the circuitry and pushbutton assembly 20 may permit for intermittent or momentary activation of the LED while the push button 20 is in a depressed position. Alternatively, the circuitry and push button assembly 20 may permit for extended activation of the LED when the push button assembly 20 is depressed and released once, and permit for deactivation of the LED when the push button assembly 20 is depressed and released a second time. As indicated above, the circuitry and push button assembly may further permit for strobe, UV, IR, or other light operation as described above.

The tensioning device 5 having an illumination source 10 such as a light emitting diode 15 permanently affixed to the tensioning device 5 assists the user or operator of the tensioning device in many ways. For example, prior to installation and use of the tensioning device 5, the illumination source(s) 10 of the tensioning device 5 may be used to identify a secure anchor point, and to assist the user in macro and micro adjustments of the device 5 while tensioning or releasing the tensioning device 5. The illumination source(s) 15 may further assist the user in locating proper footing and handholds to avoid slips and falls, and when left in the “on” position after securing cargo the illumination source(s) 10 may provide illumination to warn other motorists about a potentially dangerous condition.

The apparatus and methods of the present invention have been described with some particularity, but the specific designs, constructions and steps disclosed are not to be taken as delimiting of the invention. Obvious modifications will make themselves apparent to those of ordinary skill in the art, all of which will not depart from the essence of the invention and all such changes and modifications are intended to be encompassed within the appended claims.

What is claimed is:

1. A tensioning device for securing or containment of cargo, the tensioning device comprising:
an illumination source permanently affixed to the tensioning device and positioned to provide illumination during use of the tensioning device.

2. The tensioning device of claim 1, wherein the illumination source is positioned to provide illumination before, during, or after use of the tensioning device in securing the cargo.

3. The tensioning device of claim 1, wherein the illumination source includes one or more light emitting diodes.

4. The tensioning device of claim 3, wherein the illumination source includes intermittent or permanent actuation and deactivation functionality.

5. The tensioning device of claim 3, wherein the illumination source includes strobe or infrared functionality.

6. The tensioning device of claim 1, wherein the tensioning device is a hand-held manually operated tensioning device.

7. The tensioning device of claim 6, wherein the tensioning device is a ratchet-type tensioning device having a main ratchet portion and a terminal end.

8. The tensioning device of claim 7, wherein the illumination source is attached to the main ratchet portion.

9. The tensioning device of claim 7, wherein the illumination source is attached to the terminal end.

10. A hand-held manually operated ratchet tensioning device for securing or containment of cargo, the tensioning device comprising:
a main ratchet portion;
a terminal end;
a strap connected between the main ratchet portion and the terminal end; and
an illumination source permanently affixed to the tensioning device, the illumination source includes a light emitting diode positioned to provide illumination during use of the tensioning device.

11. The tensioning device of claim 10, wherein the illumination source is attached to the main ratchet portion.

12. The tensioning device of claim 10, wherein the illumination source is attached to the terminal end.

13. The tensioning device of claim 10, wherein the illumination source is positioned to provide illumination before, during, or after use of the tensioning device in securing the cargo.

14. The tensioning device of claim 10, wherein the illumination source includes one or more light emitting diodes.

15. A method of providing illumination during use of a ratchet tensioning device to secure cargo, the tensioning device having a main ratchet portion linked to a terminal end, the method comprising the steps of:
permanently affixing an illumination source to the tensioning device; and
positioning the illumination source to provide illumination during use of the tensioning device.

16. The method of claim 15, wherein the illumination source is attached to the main ratchet portion.

17. The method of claim 15, wherein the illumination source is attached to the terminal end portion.

18. The method of claim 15, wherein position of the illumination source permits illumination before, during, and after use of the tensioning device in securing the cargo
